(19) United States
(12) Patent Application Publication
(10) Pub. No.: US 2011/0306748 A1
(43) Pub. Date: Dec. 15, 2011

(54) Titania-alumina-tungsta extrudate and its use

(76) Inventor: Daniel Travis Shay, Glen Mills, PA (US)

(21) Appl. No.: 12/802,682

(22) Filed: Jun. 11, 2010

(51) Int. Cl. C08G 63/00; B01J 23/652; B01J 23/68; B01J 21/04

(52) U.S. Cl. 528/271; 502/439; 502/309

(57) ABSTRACT

An extrudate comprising at least 50 wt % titania, 0.5 to 25 wt % tungsta, and 0.5 to 35 wt % alumina is disclosed. The extrudate has improved crush strength compared with a titania-tungsta extrudate. A palladium catalyst prepared from the extrudate has good activity in preparing an acetoxylated olefin from an olefin, oxygen, and acetic acid.

### FIELD OF THE INVENTION

The invention relates to an extrudate comprising titania, alumina, and tungsta, and its use as a catalyst carrier.

### BACKGROUND OF THE INVENTION

Catalysts containing palladium and a Group 11 metal supported on titania are useful in catalyzing acetoxylation of olefins. See, for example, U.S. Pat. No. 6,022,823, U.S. Pat. Appl. Pub. Nos. 2008/0146721 and 2008/0281122. Titania extrudates generally have low crush strengths. Catalysts with low crush strengths tend to attrit in a reactor, cause pressure drops, and plug process lines.

Co-pending application Ser. No. 12/291,628, filed on Nov. 12, 2008, discloses a catalyst comprising palladium, gold, and a support comprising titanium dioxide and tungsten trioxide. The catalyst improves the oxygen selectivity to the formation of vinyl acetate as compared to a titania-supported palladium-gold catalyst. However, the crush strength of the catalyst is also low.

Co-pending application Ser. No. 12/657,893, filed on Jan. 29, 2010, discloses a catalyst comprising palladium supported on an extrudate comprising at least 80 wt % titania and 0.1 to 15 wt % alumina. A palladium catalyst prepared from the titania-alumina extrudate gives significantly higher crush strength and good activity.

A catalyst carrier often has significant effects on its activity and selectivity. There is a continued need for catalysts with high crush strength and good activity and selectivity.

### SUMMARY OF THE INVENTION

In one aspect, the invention is a calcined extrudate comprising at least 50 wt % titania, 0.5 to 25 wt % tungsta, and 0.5 to 35 wt % alumina. The extrudate has improved crush strength as compared to a titania-tungsta extrudate. A palladium catalyst prepared from the extrudate has good activity in producing an acetoxylated olefin from an olefin, oxygen, and acetic acid.

### DETAILED DESCRIPTION OF THE INVENTION

In one aspect, this invention is an extrudate comprising at least 50 wt % titania, 0.5 to 35 wt % alumina, and 0.5 to 25 wt % tungsta. Preferably it comprises 1 to 30 wt % alumina and 1 to 20 wt % tungsta. More preferably it comprises 10 to 30 wt % alumina and 5 to 15 wt % tungsta.

To prepare the extrudate, titania, alumina, and tungsta (tungsten trioxide) are mixed by any suitable method, such as mulling or kneading, to form a paste. Commercially, titania may be produced by the chloride process, the sulfate process, the hydrothermal process, or the flame hydrolysis of titanium tetrachloride. Examples of suitable titanias include TiONA® DT-51, DT-51D, DT-40, and DT-20 of Cristal Global. Examples of suitable aluminas include α-alumina, β-alumina, γ-alumina, boehmite, gibbsite, bayerite, nordstrandite, doyelite, and the like, and mixtures thereof. Commercially available aluminas include DISPERAL®, PURAL®, PURALOX® of Sasol. Suitable tungstas can be produced by oxidation of tungsten or decomposition of tungstates.

A mixed oxide may be used to prepare the paste. For example, titania-alumina, alumina-tungsta, titania-tungsta, or titania-alumina-tungsta may be used. For example, DT-52 of Cristal Global is a titania-tungsta mixed oxide containing 10 wt % tungsta.

A solvent is used to form the paste. Examples of suitable solvents include water, alcohols, amides, and the like, and mixtures thereof. Preferred solvents are water and alcohols. Water is the most preferred.

A titania, alumina, or tungsta precursor may be used to form the paste. Suitable titania precursors include titania sols, titanium salts, titanium halides, titanium alkoxides, titanium oxyhalides, and the like. Examples of titania precursors include titanium tetrachloride, titanium tetraethoxide, titanium tetra(isopropoxide), titanium di(isopropoxide) acetylacetonate. Suitable titania sols are described in U.S. Pat. No. 7,648,936, the teachings of which are herein incorporated by reference. Suitable alumina precursors include aluminum trihydroxide, alumina sols, aluminium alkoxides, aluminium salts, aluminum chlorhydrates, aluminum oxyhydroxides. Suitable tungsta precursors include tungsten oxides of various oxidation states (e.g., W₄₀O₁₁₉, W₅₀O₁₄₈, W₂₀O₅₈, WO₂), ammonium tungstate, tungstic acids, tungsten oxyhalides, and the like. The precursors are converted to the corresponding oxides during the paste formation, extrusion, extrudate drying, or calcination.

An extrusion aid may be used to form the paste. Suitable extrusion aids include carboxylic acids, alkyl ammonium compounds, amino alcohols, cellulose, cellulose derivatives, starch, polyacrylates, polymethacrylates, poly(vinyl alcohol)s, poly(vinylpyrrolidone)s, poly(amino acid)s, polyethers, poly(tetrahydrofuran)s, metal carboxylates, and the like, and mixtures thereof. Examples of cellulose derivatives include sodium carboxyalkylcellulose, hydroxyalkylcellulose, and methylcellulose. Preferably the extrusion aid includes a combination of a sodium carboxyalkylcellulose and a hydroxyalkylcellulose. A carboxyalkylcellulose to hydroxyalkylcellulose weight ratio of 3:1 to 1:1 is more preferred.

Carboxyalkyl cellulose is a cellulose derivative with carboxyalkyl groups bound to some of the hydroxyl groups of the glucopyranose monomers that make up the cellulose backbone. It is often used as its sodium salt, sodium carboxyalkyl cellulose. Preferably, a sodium salt of carboxymethyl cellulose is used.

Hydroxyalkyl cellulose is a derivative of cellulose in which some of the hydroxyl groups in the repeating glucose units have been hydroxyalkylated. Preferably the hydroxyalkyl group is a 2-hydroxyethyl or 2-hydroxypropyl group.

Extrusion of the paste produces an extrudate, which contains solvent and possibly extrusion aids. Extrusion is a manufacturing process in which a paste is pushed through a die or an orifice to create long objects of a fixed cross-section. Extrusion is commonly used to process plastics or food, and to form adsorbents or catalysts. Any conventional extruder may be used. The extrudate usually has a diameter of 0.5 to 10 mm, in particular from 1 to 5 mm. A suitable screw-type extruder is described in “Particle Size Enlargement,” Handbook of Powder Technology, vol. 1 (1980) pp. 112-22.

The calcined extrudate is obtained by burning off the organic materials in the extrudate (e.g., residual solvent, extrusion aids, and the like) in an oxygen-containing gas. The calcination may be carried out at 400 to 1000° C., more preferably from 450 to 700° C. Sometimes, it is beneficial to initially calcine the extrudate in an inert atmosphere (e.g., nitrogen, helium) to thermally decompose the organic compounds contained in the extrudate, and then burn off the organic materials in an oxygen-containing atmosphere.

The calcined extrudate preferably has a surface area in the range of 5 to 200 m²/g, more preferably in the range of 10 to 150 m²/g. The calcined extrudate generally has higher crush strength than a titania-tungsta extrudate (Examples 1-3).

In another aspect, the invention is a catalyst comprising palladium supported on the calcined extrudate. Preferably, the catalyst contains 0.05 to 3 wt % palladium. Optionally, the catalyst further comprises a Group 11 metal, preferably in the amount of from 0.05 to 1.5 wt %. More preferably, the catalyst contains from 0.5 to 1.5 wt % palladium and from 0.25 to 0.75 wt % gold.

To prepare the catalyst, the calcined extrudate is typically treated with an aqueous solution of a palladium salt. The concentrations and the amounts of solutions used depend on the desired concentrations of palladium in the final catalyst. Water is then removed leaving the palladium salt deposited on the extrudate. Suitable palladium salts include palladium chloride, sodium chloropalladite, palladium nitrate, and palladium sulfate. A Group 11 metal salt may be added to the calcined extrudate along with the palladium addition or in a separate step. For example, an aqueous solution of auric chloride, tetrachloroauric acid, sodium tetrachloroaurate, and the like may be used.

The impregnated extrudate is calcined at a temperature in the range of 100° C. to 600° C. in an inert or oxidizing gas such as helium, nitrogen, argon, neon, nitrogen oxides, oxygen, air, carbon dioxide, and the like. Mixtures of the aforementioned gases may also be used. Preferably the calcination is carried out in nitrogen, oxygen or air, or mixtures thereof, typically for 0.1 to 5 h.

Following the calcination, the resulting product is reduced to convert at least a portion of the palladium, and the Group 11 metal if used, to produce a reduced catalyst. In general, any known procedure using conventional reducing agents such as ammonia, carbon monoxide, hydrogen, hydrocarbons, olefins, aldehydes, alcohols, hydrazine, primary amines, carboxylic acids, carboxylic acid salts, and carboxylic acid esters can be used. Hydrogen, ethylene, propylene, alkaline hydrazine, and alkaline formaldehyde are highly useful reducing agents; and ethylene and hydrogen are particularly preferred. While pure hydrogen may be used, it is more common to use a mixture of hydrogen and an inert gas such as nitrogen, helium, argon, or the like. These mixtures generally contain up to about 50 volume percent (vol %) hydrogen and, more typically, are comprised of about 5 to 25 vol % hydrogen and 75 to 95 vol % inert gas. Reduction times typically vary from 0.1 to 5 h. Temperatures employed for the reduction can range from 20 to 600° C.

The catalyst may be used for the acetoxylation of an olefin, such as ethylene or propylene, to produce an acetoxylated olefin such as vinyl acetate or allyl acetate. Preferably, a promoted catalyst, which can be produced by adding an activator to the reduced catalyst, is used in the acetoxylation reaction. The activator is preferably an alkali or alkaline earth metal compound, examples of which are hydroxides, acetates, nitrates, carbonates, and bicarbonates of potassium, sodium, cesium, magnesium, barium, and the like. Potassium salts are preferred activators. The activator content may be in the range of 0.1 to 15 wt %, preferably 0.5 to 10 wt % of the catalyst.

The invention also includes a process for preparing an acetoxylated olefin, comprising reacting a feed comprising an olefin, oxygen, and acetic acid in the presence of the catalyst. Preferably the olefin is ethylene or propylene. More preferably the olefin is ethylene.

The feed typically comprises 20 to 70 mol % olefin, 2 to 8 mol % oxygen, and 2 to 20 mol % acetic acid. The feed may comprise a diluent. Examples of suitable diluents include ethane, propane, nitrogen, helium, argon, carbon dioxide, the like, is and mixtures thereof.

The reaction is generally performed in a fixed-bed reactor at a temperature in the range of 100 to 250° C., preferably 125 to 200° C. and under a pressure of 15 to 500 psig.

### EXAMPLE 1

### Preparation of Calcined Extrudate

DT-52 titania-taungta (162 g), alumina (DISPERAL® P2, available from Sasol, 18 g), a high-purity WALOCEL™ C sodium carboxymethyl cellulose (The Dow Chemical Company, 3.8 g), poly(ethylene oxide) (MW=100,000, 3.4 g), and a cellulose derivative (METHOCEL™ K4M from The Dow Chemical Company, 1.8 g) are mixed for 5 min. Water (100 g), an aqueous ammonium hydroxide (14.8 M, 10.5 g), and benzyl alcohol (1.3 g) are added into the mixture and further mixed to produce a paste. The paste is placed in the hopper of a Bonnot 1-inch extruder (The Bonnot Company) equipped with a die face of 2 holes with a diameter of ⅛ inch.

The extrudates are collected and dried in air at 80° C. for 12 h, then calcined in air. The temperature is raised from room temperature to 500° C. at a rate of 2° C./min, held at 500° C. for 2 h, raised from 500° C. to 700° C. at a rate of 10° C./min, held at 700° C. for 3 h, then lowered to room temperature.

Some physical properties of the calcined extrudate are listed in Table 1. The crush strength of the extrudate is measured with a Chatillon crush strength analyzer (Model DPP 50). The force necessary for failure in 25 measurements of ⅛ inch long extrudates is averaged to give the reported value. Bulk density is measured by placing 40 g of the extrudates in a 100-mL graduated cylinder (1″ nominal outer diameter). The graduated cylinder is tapped until the apparent volume no longer changes, and then this value is divided into the mass to calculate the bulk density. Voidage is determined by adding the pellets to 50 mL water in a second graduated cylinder and then tapping until all voids are filled. The resulting water level is subtracted from the total volume of the water and the pellets taken separately to determine the void volume occupied by water. Total pore volume is determined by pouring the mixture through a sieve basket, shaking to remove excess water and then weighing the wet extrudates. The increase in mass over the initial 40 g of the extrudate divided by the density of water is taken as the measure of the pore volume.

### Pd-Au Catalyst

NaHCO₃ powder (2.7 g) is slowly added to an aqueous solution containing Na₂PdCl₄·3H₂O (2.8 g), NaAuCl₄·2H₂O (1.1 g), and water (23.5 g). The mixture is stirred at room temperature for 10 min. The solution is sprayed with a pipette on the calcined extrudates (100 g) while they are being tumbled in a rotating flask. Once the impregnation is finished, the rotating flask is heated to about 100° C. with a heat gun. The impregnated extrudates are tumbled for another 30 min at 100° C., then placed in an oven at 80° C. for 2 h before they are cooled to room temperature.

The dried extrudates are washed with warm water (50 to 80° C.) until no chloride can be detected by mixing the wash filtrate solution with a 1 wt % silver nitrate solution to observe precipitation. After washing is finished, the catalyst is dried at 80 to 100° C. to remove water. Then they are heated at 230° C. for 3 h in air, and at 230° C. for 30 min under a nitrogen flow. The temperature is raised to 500° C. under a flow of 10 mol % hydrogen in nitrogen gas, and held for 3 h before it is cooled to room temperature.

The extrudates are washed with an aqueous solution containing 10 wt % potassium acetate and 1 wt % potassium hydroxide (1 L). The washed extrudates are dried under nitrogen at 125° C. for 2 h. A palladium-gold catalyst is obtained. It contains 0.87 wt % Pd, 0.57 wt % Au, and 1.5 wt % K.

### Vinyl Acetate Production

The palladium-gold catalyst is tested for vinyl acetate production in a fixed-bed reactor (stainless steel, 1 inch O.D.). The reactor is charged with a mixture of the catalyst (8.6 g) and inert alpha alumina cylindrical pellets (⅛″ in diameter, surface area 4 m²/g, pore volume 0.25 mL/g, 25 g). The feed contains 47.3 mol % helium, 33.1 mol % ethylene, 11.6 mol % acetic acid, 4.0 mol % oxygen, and 3.9 mol % nitrogen. The reactor pressure is 80 psig and the space velocity relative to the volume of the catalyst is 3050 h⁻¹ at standard temperature and pressure. The reactor is cooled using a fluidized sand bath, the temperature of which is set at 130° C. The product stream is analyzed by gas chromatography (GC). Oxygen conversion, oxygen selectivity, oxygen yield to vinyl acetate, and ethylene selectivity to vinyl acetate at 24 h on stream are calculated from the GC results and listed in Table 1. Oxygen conversion is calculated by dividing the amount of oxygen consumed by the total amount of oxygen fed to the reactor. Oxygen selectivity to vinyl acetate is the amount of oxygen consumed in making vinyl acetate divided by the total amount of oxygen consumed. Oxygen yield to vinyl acetate is the product of oxygen conversion multiplied by oxygen selectivity. Ethylene selectivity to vinyl acetate is the amount of ethylene consumed in making vinyl acetate divided by the total amount of ethylene consumed. Catalyst productivity is the grams of vinyl acetate produced per liter of the catalyst per hour.

### EXAMPLE 2

The procedure of Example 1 is repeated with the formulation shown in Table 1.

### COMPARATIVE EXAMPLE 3

The procedure of Example 1 is repeated with the formulation shown in Table 1.

### COMPARATIVE EXAMPLE 4

The procedure of Example 1 is repeated with the formulation shown in Table 1. DT-51 titania (144 g) is used instead of DT-52 titania-taungta.

Table 1 shows that the titania-alumina-tungsta extrudates in Examples 1 and 2 have lower porosities than the titania-tungsta extrudate of Comparative Example 3, but higher surface areas and much greater crush strengths. The palladium-gold catalysts of Examples 1 and 2 give higher oxygen selectivities to vinyl acetate and higher ethylene selectivities to vinyl acetate as compared to the catalyst of Comparative Example 3. The catalysts in Examples 1 and 2 have much higher crush strengths than that of Comparative Example 3.

Table 1 also shows that the overall performance of catalysts in Examples 1 and 2 are better than that of Comparative Example 4.

TABLE 1

| Example | 1 | 2 | C. 3 | C. 4 |
|---|---|---|---|---|
| Extrudate formulation | | | | |
| DT-52 titania-tungsta (g) | 162 | 144 | 180 | |
| DT-51 titania (g) | | | | 144 |
| DISPERAL ® P2 alumina (g) | 18 | 36 | 0 | 36 |
| Extrudate composition | | | | |
| Titania (wt %) | 81 | 72 | 90 | 80 |
| Tungsta (wt %) | 9 | 8 | 10 | |
| Alumina (wt %) | 10 | 20 | 0 | 20 |
| Extrudate characterization | | | | |
| Crush strength (lb per ⅛ inch) | 12 | 14 | 4 | 25 |
| Porosity (mL per 100 g) | 49 | 48 | 55 | 45 |
| Surface area (m²/g) | 70 | 88 | 53 | 101 |
| Catalyst characterization | | | | |
| Pd (wt %) | 0.87 | 0.84 | 0.84 | 0.89 |
| Au (wt %) | 0.57 | 0.59 | 0.55 | 0.53 |
| Catalyst performance | | | | |
| Oxygen conversion (%) | 43.4 | 62.8 | 60.6 | 47.7 |
| Oxygen selectivity to vinyl | 72.8 | 69.9 | 64.0 | 69.5 |
| acetate (%) | | | | |
| Oxygen yield to vinyl acetate (%) | 31.6 | 43.9 | 38.8 | 33.1 |
| Ethylene selectivity to vinyl | 94.0 | 93.2 | 91.3 | 93.0 |
| acetate (%) | | | | |
| Catalyst productivity (g · L⁻¹ · h⁻¹) | 310 | 430 | 380 | 324 |

I claim:

1. A calcined extrudate comprising at least 50 wt % titania, 0.5 to 25 wt % tungsta, and 0.5 to 35 wt % alumina.

2. The extrudate of claim 1 wherein the extrudate comprises 10 to 30 wt % alumina and 5 to 15 wt % tungsta.

3. The extrudate of claim 1 having a surface area of 5 to 200 m²/g.

4. The extrudate of claim 1 having a surface area of 10 to 150 m²/g.

5. The extrudate of claim 1 produced in the presence of an extrusion aid comprising a carboxyalkyl cellulose and a hydroxyalkyl cellulose.

6. A catalyst comprising palladium supported on the extrudate of claim 1.

7. The catalyst of claim 6 wherein the amount of palladium is 0.05 to 3 wt % of the catalyst.

8. The catalyst of claim 6 wherein the extrudate comprises 10 to 30 wt % alumina and 5 to 15 wt % tungsta.

9. The catalyst of claim 6 further comprising a Group 11 metal.

10. The catalyst of claim 9 wherein the Group 11 metal is gold.

11. A process for preparing an acetoxylated olefin comprising reacting an olefin, oxygen, and acetic acid in the presence of the catalyst of claim 6.

12. The process of claim 11 wherein the extrudate comprises 10 to 30 wt % alumina and 5 to 15 wt % tungsta.

13. The process of claim 11 wherein the extrudate has a surface area of 5 to 200 m²/g.

14. The process of claim 11 wherein the catalyst further comprises a Group 11 metal.

15. The process of claim 11 wherein the olefin is ethylene.
